(19) United States
(12) Patent Application Publication
(10) Pub. No.: US 2015/0172637 A1
(43) Pub. Date: Jun. 18, 2015

(54) APPARATUS AND METHOD FOR GENERATING THREE-DIMENSIONAL OUTPUT DATA

(71) Applicant: ELECTRONICS AND TELECOMMUNICATIONS RESEARCH INSTITUTE, Daejeon-city (KR)

(72) Inventors: Seung-Uk YOON, Daejeon (KR); Bon-Woo HWANG, Daejeon (KR); Seong-Jae LIM, Daejeon (KR); Kap-Kee KIM, Daejeon (KR); Hye-Ryeong JUN, Daejeon (KR); Jin-Sung CHOI, Daejeon (KR); Bon-Ki KOO, Daejeon (KR)

(21) Appl. No.: 14/569,258

(22) Filed: Dec. 12, 2014

(30) Foreign Application Priority Data
Dec. 12, 2013 (KR) 10-2013-0154598
Oct. 24, 2014 (KR) 10-2014-0144759

(51) Int. Cl. H04N 13/02; G06T 17/00; G06T 7/00; G06T 7/40

(52) U.S. Cl. CPC H04N 13/0246; G06T 7/40; G06T 7/408; G06T 17/00; G06T 7/0075

(57) ABSTRACT

Disclosed are an apparatus and a method for generating three-dimensional output data, in which the appearance or face of a user is easily restored in a three-dimensional manner by using one or a plurality of cameras including a depth sensor, a three-dimensional avatar for an individual, which is produced through three-dimensional model transition, and data capable of being three-dimensionally output, which is generated based on the three-dimensional avatar for an individual. The apparatus includes an acquisition unit that acquires a three-dimensional model based on depth information and a color image from at least one point of view, a selection unit that selects at least one of three-dimensional template models, and a generation unit that modifies at least one of a plurality of three-dimensional template models selected by the selection unit and generates three-dimensional output data based on the three-dimensional model acquired by the acquisition unit.

### CROSS REFERENCE TO RELATED APPLICATION

This application claims the benefit of Korean Patent Application Nos. 10-2013-0154598, filed Dec. 12, 2013 and 10-2014-0144759, filed Oct. 24, 2014, which is hereby incorporated by reference in its entirety into this application.

### BACKGROUND OF THE INVENTION

1. Technical Field

The present invention relates generally to an apparatus and a method for generating three-dimensional output data and, more particularly, to an apparatus and a method for generating three-dimensional output data, in which the appearance or face of a user is easily restored in a three-dimensional manner by using one or a plurality of cameras including a depth sensor, wherein a three-dimensional avatar for an individual is produced through three-dimensional model transition, and data capable of being three-dimensionally output is generated based on the three-dimensional avatar for an individual.

2. Description of the Related Art

Conventional methods of restoring three-dimensional appearances or face images using a stereo camera are problematic in that a calculation time and a restoration result vary with the characteristics and resolution of a camera, that the restoration result is largely affected by illumination conditions at the time of capturing, and that restoration may not be normally performed when a person to be captured moves since accurate synchronization is necessary.

Furthermore, separate hardware or software processing for removing a background from a subject of a photo or video is necessary. Highly precise restoration data can be obtained when pictures of the object are taken while he or she is maximally stationary under the condition of controlled illumination settings, a plurality of cameras selected according to applications, and a special device (chroma key) arranged at a verified position to remove the background from the subject. However, it is very difficult for a general user to produce his/her own three-dimensional avatar easily and simply by using a conventional system.

A technology of restoring a three-dimensional appearance or face image from data captured by such a general-purpose camera installed in a cellular phone is very poor in restoration accuracy, and thus is used only for entertainment purposes where accurate representations are not required.

A conventional method of restoring three-dimensional appearances or face images using a depth sensor or a depth camera (the depth sensor or the depth camera may be based on a structured light scheme or time of flight (TOF)) is principally performed in an indoor illumination environment, but does not require additional processing for background removal.

Unlike stereo cameras, depth sensors or cameras are not largely affected by illumination, and since most depth sensors or cameras have a depth resolution fixed at 640×480 pixels or less, their deviation in a restoration result is small. The extraction of depth information generates much noise because it is done in units of pixels, but can be performed in real time.

Recently, there has also been developed an approach using such real-time depth extraction characteristics in restoring an entire three-dimensional appearance in which a user scans (as if using a handheld scanner) the areas surrounding a subject with a depth camera such as Kinect™ to align and match the captured frames, consequently improving restoration accuracy.

However, the method of accumulating large amounts of three-dimensional vertex data (point clouds) extracted from each frame creates too large of an amount of restored data and too much noise to be directly used in various applications. Additionally, texture quality is low due to the lack of color information (Kinect™ has a color resolution of 1024×768 pixels, and there are many TOF cameras having no color information storage function), and even when a low-resolution texture is applied to appearance restoration data with much noise, it is difficult to generate a three-dimensional avatar that resembles a user.

Recently, as three-dimensional printing has been come into the spotlight, there have been attempts to output various three-dimensional subjects through a three-dimensional printer.

Much three-dimensional model data is now directly produced by users using authoring tools, and exists on the Internet. However, since the data is not produced for the specific purpose of three-dimensional printing, it is not suitable for use in printing via a three-dimensional printer.

For example, since an existing three-dimensional model is fully filled, its output through a three-dimensional printer needs a lot of materials.

Therefore, many of the existing three-dimensional models should be edited or newly produced to have characteristics (thickness or hollowness) appropriate for three-dimensional printing. Furthermore, some three-dimensional models can be output without failure only when utilizing a physical simulation function that has recently been provided by some software.

Until a general user can easily produce his/her own three-dimensional avatar and output it three-dimensionally, he or she, although able to acquire heavy appearance restoration data having much noise in a first step, may encounter difficulty in subsequent steps, which do not seem to be associated with each other and require special knowledge thereabout.

There is therefore a need for an apparatus and method, overcoming problems encountered with the conventional art, for generating three-dimensional output data, in which the appearance or face of a user is easily restored in a three-dimensional manner by using one or a plurality of cameras including a depth sensor; and a three-dimensional avatar for an individual is produced through three-dimensional model transition, and data capable of being three-dimensionally output is generated based on the three-dimensional avatar for an individual. A related technology is disclosed in Korean Patent Application Publication No. 2006-0045798.

### SUMMARY OF THE INVENTION

Accordingly, the present invention has been made keeping in mind the above problems occurring in the conventional art, and an object of the present invention is to allow three-dimensional personal avatars to be produced by easily restoring three-dimensional appearance of a whole body or face of a subject with one or a plurality of cameras equipped with a depth sensor, and modifying the three-dimensional appearance using a three-dimensional model transition technology to create a three-dimensional avatar resembling, to the greatest possible degree, a model restored from a three-dimensional light reference model having no noise.

Another object of the present invention is to set in advance the type of a reference model suitable for an output form in consideration of various types of three-dimensional output (three-dimensional printing, lenticular printing, three-dimensional animation and the like), thereby enabling a general user to directly process the restoration to the output of a his/her own three-dimensional avatar.

In accordance with an aspect thereof, the present invention provides an apparatus for generating three-dimensional output data, comprising: an acquisition unit for acquiring a three-dimensional model based on depth information and a color image for a user of at least one point of view; a selection unit for selecting at least one of a plurality of three-dimensional template models based on a type of output and an application according to utilization of the three-dimensional model; and a generation unit for modifying at least one of a plurality of three-dimensional template models selected by the selection unit and generating three-dimensional output data based on the three-dimensional model acquired by the acquisition unit.

In one embodiment, the acquisition unit acquires the depth information and the color image through a depth camera.

In another embodiment, the acquisition unit acquires the depth information through a depth camera and acquires the color image through a color camera.

In another embodiment, the acquisition unit acquires the three-dimensional model based on the depth information and the color image acquired, respectively, from the depth camera and the color camera, said depth camera being located so that its depth sensor is coincident in the positions on X-Y axes of a three-dimensional coordinate system with a center of the lens of the color camera.

In another embodiment, the acquisition unit comprises a conversion section for performing coordinate transformation of a three-dimensional point cloud accumulated in correspondence with real-time movement of a user.

In another embodiment, the acquisition unit further comprises a correction section for performing correction for the depth camera and the color camera to make mapping between the depth information and the color image.

In another embodiment, the acquisition unit further comprises: an alignment section for aligning a color texture and a three-dimensional appearance acquired by the depth camera and the color camera corrected by the correction section to generate the three-dimensional model.

In another embodiment, the selection unit selects at least one of a three-dimensional template model corresponding to three-dimensional printing and a three-dimensional template model corresponding to a three-dimensional animation application.

In another embodiment, the three-dimensional template model corresponding to three-dimensional printing is hollow and has a predetermined outer surface thickness based on material efficiency for the printing of the output, and stability of the output itself.

In another embodiment, the three-dimensional template model corresponding to a three-dimensional animation application is obtained by limiting a number of vertices of the three-dimensional template model to a predetermined number or less, or is obtained by reducing a number of vertices for a part, in which movement in the three-dimensional template model has a value equal to or less than a predetermined value by a predetermined number.

In accordance with another aspect thereof, the present invention provides a method of generating three-dimensional output data, comprising: acquiring, by an acquisition unit, a three-dimensional model based on depth information and a color image for a user of at least one point of view; selecting, by a selection unit, at least one of a plurality of three-dimensional template models based on a type of output and an application according to utilization of the three-dimensional model; and modifying, by a generation unit, at least one of a plurality of three-dimensional template models selected by the selection unit and generating three-dimensional output data based on the three-dimensional model acquired by the acquisition unit.

In one embodiment, the acquiring is carried out by use of a depth camera to acquire the depth information and the color image.

In another embodiment, the acquiring is carried out by use of a depth camera to acquire the depth information and by use of a color camera to acquire the color image.

In another embodiment, the acquiring is carried out based on the depth information and the color image acquired, respectively, from the depth camera and the color camera, said depth camera being located so that its depth sensor is coincident in the positions on X-Y axes of a three-dimensional coordinate system with a center of the lens of the color camera.

In another embodiment, the acquiring comprises: performing, by a conversion section, coordinate transformation of a three-dimensional point cloud accumulated in correspondence with real-time movement of a user.

In another embodiment, the acquiring further comprises: performing, by a correction section, correction for the depth camera and the color camera and performing mapping between the depth information and the color image, after the coordinate transformation of a three-dimensional point cloud is performed.

In another embodiment, the acquisition unit further comprises: aligning, by an alignment section, a color texture and a three-dimensional appearance acquired by the depth camera and the color camera corrected in the mapping between the depth information and the color image, and generating the three-dimensional model, after the mapping between the depth information and the color image is performed.

In another embodiment, the selecting is carried out by selecting at least one of a three-dimensional template model corresponding to three-dimensional printing and a three-dimensional template model corresponding to a three-dimensional animation application.

In another embodiment, the three-dimensional template model corresponding to three-dimensional printing is hollow and has a predetermined outer surface thickness based on material efficiency for the printing of the output, and stability of the output itself.

In another embodiment, the three-dimensional template model corresponding to a three-dimensional animation application is obtained by limiting a number of vertices of the three-dimensional template model to a predetermined number or less, or is obtained by reducing a number of vertices for a part, in which movement in the three-dimensional template model has a value equal to or less than a predetermined value, by a predetermined number.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for generating three-dimensional output data according to the present invention;

FIG. 2 is a diagram for explaining the acquisition of a three-dimensional model by an acquisition unit of an apparatus for generating three-dimensional output data according to the present invention;

FIG. 3 is a diagram for explaining an acquisition unit of an apparatus for generating three-dimensional output data according to the present invention;

FIG. 4 is a flowchart of a method for generating three-dimensional output data according to the present invention; and

FIG. 5 is a diagram for explaining acquiring of a three-dimensional model in a method for generating three-dimensional output data according to the present invention.

### DESCRIPTION OF THE PREFERRED EMBODIMENTS

Embodiments of the present invention will be described in detail with reference to the accompanying drawings. In the following description of the present invention, the same reference numerals are used to designate the same or similar elements throughout the drawings and repeated descriptions of the same components will be omitted.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Also, the terms “a first”, “a second”, “A”, “B”, “(a), “(b)”, and the like may be employed in elucidating elements of the present invention, However, these terms are to discriminate the elements from other elements, but not to limit the nature, sequence or order of the corresponding elements thereby.

Hereinafter, an apparatus for generating three-dimensional output data according to an embodiment of the present invention for obtaining the aforementioned objects will be described with reference to the accompanying drawings.

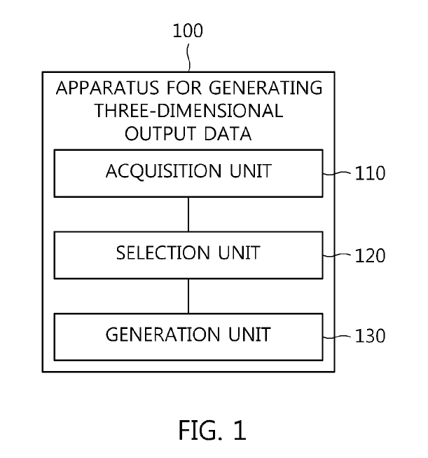

FIG. 1 is a block diagram of an apparatus for generating three-dimensional output data according to the present invention.

Referring to FIG. 1, an apparatus 100 for generating three-dimensional output data according to the present invention includes an acquisition unit 110, a selection unit 120, and a generation unit 130.

In more detail, the apparatus 100 for generating three-dimensional output data according to the present invention includes the acquisition unit 110 for acquiring a three-dimensional model based on depth information and a color image for a user from at least one point of view, the selection unit 120 for selecting at least one of a plurality of three-dimensional template models based on the type of output and applications according to the utilization of the three-dimensional model, and the generation unit 130 for modifying at least one of a plurality of three-dimensional template models selected by the selection unit 120 and generating three-dimensional output data based on the three-dimensional model acquired by the acquisition unit 110.

The acquisition unit 110 performs a function of acquiring the three-dimensional model based on the depth information and the color image for the user from at least one point of view.

In this regard, the acquisition unit 110 may acquire the depth information and the color image through a depth camera.

Furthermore, when it is difficult for the depth camera to acquire the color image, a separate color camera may be used in order to acquire the color image.

For acquiring the three-dimensional model, various input devices and imaging sensors may be used. In an embodiment of the present invention, a description will be provided for the case of acquiring input data from a device capable of acquiring depth information and a color image from at least one point of view.

Also, it may be possible to use an input device including a depth sensor capable of acquiring multiple viewpoint information. That is, the main technical characteristics of the present invention do not rely on the data acquisition sensor and device itself, but on a three-dimensional model acquisition method.

A conventional depth sensor-based three-dimensional face model generation method is implemented by scanning a face with a depth camera moving around the face, storing the scan data, and matching point cloud data.

When a plurality of depth cameras are used simultaneously, data about a user can be acquired from the depth cameras in a stationary state, and matched with each other to generate a three-dimensional face model.

The use of a depth camera alone results in generating a poor texture quality of three-dimensional face because of its poor or limited color image resolution.

In one embodiment of the present invention, a user's head is bobbed up and down or moved from side to side in front of a fixed depth camera in order for the acquisition unit 110 to acquire a three dimensional face model.

For a three-dimensional whole-body model, a user may make a simple gesture such as turning his/her body right and left in front of a depth camera.

This is configured to readily utilize a depth camera to acquire input images because widely spread depth cameras are, for the most part, used together with game machines for home use, or mounted in a stationary manner around a TV.

It is highly probable that depth cameras to be launched in the future will be fixed around a TV set or at a specific position. Alternatively, a depth camera may be built into a TV set. In consideration of either case, the acquisition of input data by directly moving the depth camera is inadequate for general users.

When the depth camera lacks a color sensor, a color camera may be separately used to acquire a texture. When a depth camera is equipped with a color sensor, the depth camera may be used, even though alone.

For both cases, however, correction between color and depth sensors is necessary. Without accurate correction, the restored facial appearance and texture cannot be matched with harmony.

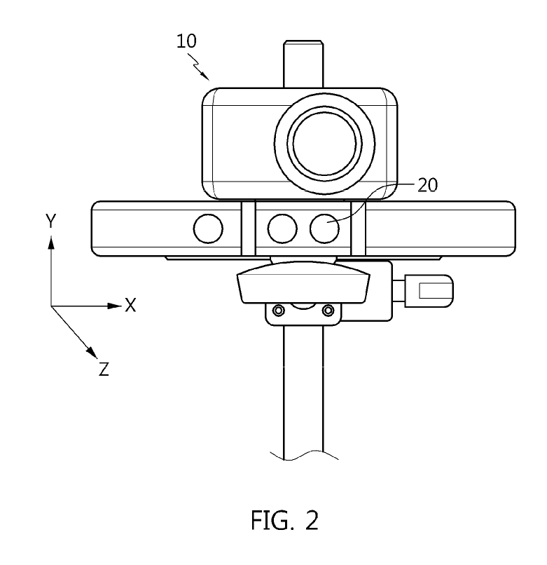

FIG. 2 is a diagram for explaining the acquisition of a three-dimensional model by the acquisition unit of the apparatus for generating three-dimensional output data according to the present invention.

Referring to FIG. 2, a separate color camera 10 is employed while a depth camera 20 is located so that its depth sensor is coincident in the positions on X-Y axes of a three-dimensional coordinate system with the center of the lens of the color camera 10 in order to minimize a correction error.

Like this, depth information is extracted from a moving user and accumulated in real time during which it is possible to check a region in which acquired data is insufficient and to recapture the region, thereby improving the restoration quality of a three-dimensional face appearance.

A color texture of an image is difficult to acquire while the subject is moving. Hence, it may be acquired in a stationary state in which the subject, for example, either is about to move or stops moving, looking at the camera. When the depth camera takes pictures of an indoor space while moving, the present invention can take advantage of the existing research on the three-dimensional restoration of scanned scenes in real time (R. A. Newcombe, S. Izadi, O. Hilliges, D. Molyneaux, D. Kim, A. J. Davison, P. Kohli, J. Shotton, S. Hodges, and A. Fitzgibbon, “KinectFusion: Real-Time Dense Surface Mapping and Tracking,” IEEE International Symposium on Mixed and Augmented Reality, pp. 127-136, 2011.). In this case, the restoration can be achieved only by coordinate transformation through which the movement of a camera is converted into that of a user.

In the existing research, depth values extracted in real time from the depth camera 20 are accumulated with time (from 1-2 frames to several frames according to buffer size) to infer relatively accurate three-dimensional information on a stationary subject.

Furthermore, repetitive scanning of the same position accumulates information thereon, increasing the degree of accuracy.

In order to realize in detail the principles of the research in the present invention, the configuration of the acquisition unit 110 will be described with reference to the accompanying drawings.

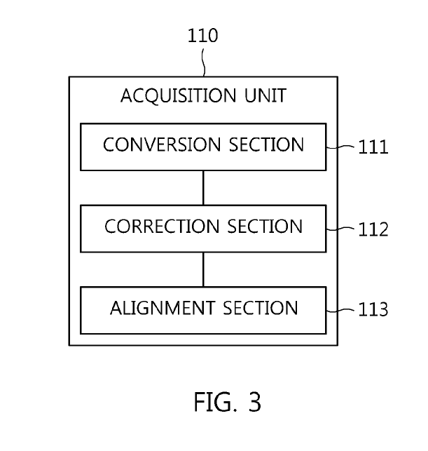

FIG. 3 is a diagram for explaining the acquisition unit of the apparatus for generating three-dimensional output data according to the present invention.

Referring to FIG. 3, the acquisition unit 110 may include a conversion section 111, a correction section 112, and an alignment section 113.

The conversion section 111 performs coordinate transformation of three-dimensional point clouds accumulated in correspondence with the real-time movement of a user.

In the correction section 112, correction for the depth camera and the color camera is made to perform mapping between the depth information and the color image.

The alignment section 113 functions to align the color texture and three-dimensional appearance acquired by the depth camera and the color camera corrected by the correction section 112 to generate a three-dimensional model.

Hereinafter, the selection unit 120 and the generation unit 130 of the apparatus for generating three-dimensional output data according to the present invention will be described.

The selection unit 120 performs a function of selecting at least one of three-dimensional template models based on the type of output and applications according to the three-dimensional model.

In detail, the selection unit 120 may select at least one of a three-dimensional template model corresponding to three-dimensional printing and a three-dimensional template model corresponding to a three-dimensional animation application. In an embodiment of the present invention, the three-dimensional template model can be designated in advance.

In this regard, the three-dimensional template model corresponding to three-dimensional printing may be hollow and may have a predetermined outer surface thickness based on material efficiency for the printing of the output, and stability of the output itself.

Furthermore, the three-dimensional template model corresponding to a three-dimensional animation application may be obtained by limiting the number of vertices of the three-dimensional template model to a predetermined number or less.

Preferably, the number of vertices of the three-dimensional template model may be limited to 10,000 or less.

Furthermore, the three-dimensional template model corresponding to a three-dimensional animation application may be obtained by reducing the number of vertices for a part, in which movement in the three-dimensional template model has a value equal to or less than a predetermined value, by a predetermined number.

The generation unit 130 functions to modify at least one of a plurality of three-dimensional template models selected by the selection unit 120 and generate three-dimensional output data based on the three-dimensional model acquired by the acquisition unit 110.

In detail, the generation unit 130 supports the function of directly modifying the three-dimensional template model selected by the selection unit 120 to create a model resembling the three-dimensional model acquired by the acquisition unit 110 to a greatest possible degree.

As described above, the apparatus 100 according to the present invention can generate three-dimensional output data according to various applications without largely depending on the degree of precision of an acquired three-dimensional model, and enjoys the advantage of satisfying a processing time and a restoration quality level according to requirement by variably adjusting the degree of transition through the generation unit 130.

In an embodiment of the present invention, if a general user has a depth camera, capable of acquiring a color image, for a video game machine, he or she can easily generate a three-dimensional avatar resembling himself or herself by use of the apparatus 100 for generating three-dimensional output data according to the present invention, and can produce the three-dimensional avatar in a data format which can be output through a three-dimensional printer or a lenticular printer.

Hereinafter, a method for generating three-dimensional output data according to the present invention will be described. As described above, a description for the technical content overlapping the apparatus 100 for generating three-dimensional output data according to the present invention will be omitted.

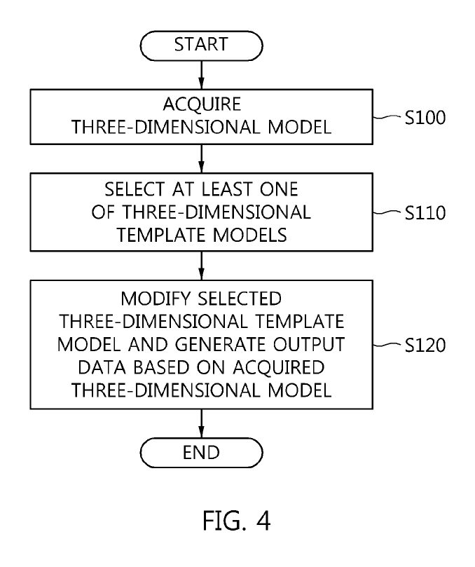

FIG. 4 is a flowchart of the method for generating three-dimensional output data according to the present invention.

Referring to FIG. 4, the method for generating three-dimensional output data according to the present invention starts with acquiring a three-dimensional model based on depth information and a color image for a user from at least one point of view (S100), which is implemented by the acquisition unit.

In step S110, then, at least one of a plurality of three-dimensional template models is selected based on the type of output and applications according to the utilization of the three-dimensional model, as the selection unit works. After step S110, based on the three-dimensional model acquired by the acquisition unit, at least one of a plurality of three-dimensional template models selected by the selection unit are modified, and three-dimensional output data are generated, as the generation unit works, in step S120.

In an embodiment of the present invention, the number of vertices of the three-dimensional model acquired by the acquisition unit (S100) may be larger than the number of vertices of the three-dimensional template model selected by the selection unit (S110).

In an embodiment of the present invention, in step S120, the generation unit may modify at least one of a plurality of three-dimensional template models which have small number of vertices, similar to appearance of an input model, based on the three-dimensional model which has large number of vertices.

It is difficult for the acquired three-dimensional model to be modified because of noise and weight. Therefore, the generation unit may modify the three-dimensional template models.

In an embodiment of the present invention, in step S110, selection may be made of at least one of a three-dimensional template model corresponding to three-dimensional printing and a three-dimensional template model corresponding to a three-dimensional animation application.

In more detail, the three-dimensional template model corresponding to three-dimensional printing may be hollow and may have a predetermined outer surface thickness based on material efficiency for the printing of the output, and stability of the output itself.

Furthermore, the three-dimensional template model corresponding to a three-dimensional animation application may be obtained by limiting the number of vertices of the three-dimensional template model to a predetermined number or less.

Preferably, the number of vertices of the three-dimensional template model may be limited to 10,000 or less.

In addition, the three-dimensional template model corresponding to a three-dimensional animation application may be obtained by reducing the number of vertices for a part, in which movement in the three-dimensional template model has a value equal to or less than a predetermined value, by a predetermined number.

Hereinafter, the acquiring step S100 will be described in detail with reference to the accompanying drawing.

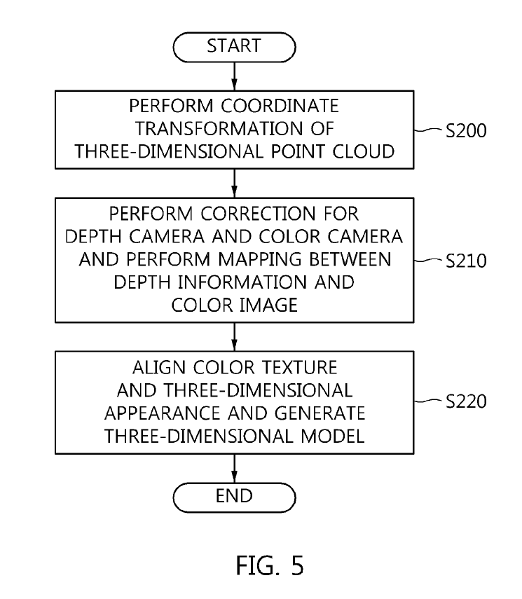

FIG. 5 is a diagram for explaining the acquiring of the three-dimensional model in the method for generating three-dimensional output data according to the present invention.

Referring to FIG. 5, the acquiring step S100 starts with the coordinate transformation of three-dimensional point clouds accumulated in correspondence with the real-time movement of a user, as the conversion section works (S200). After step S200, step S100 may proceed by performing correction for the depth camera and the color camera in the correction section to map between the depth information and the color image (S210).

After step S210, step S100 may further include aligning the color texture and the three-dimensional appearance acquired by the depth camera and the color camera corrected in step S210 of performing mapping between the depth information and the color image, and generating a three-dimensional model, as the alignment section works (S220).

As described hereinbefore, the apparatus 100 and the method for generating three-dimensional output data according to the present invention can easily restore the three-dimensional appearance of a whole body or a face of a subject with one or many cameras equipped with a depth sensor, and can modify the three-dimensional appearance using a three-dimensional model transition technology to create a three-dimensional avatar resembling, to the greatest possible degree, a model restored from a three-dimensional light reference model having no noise. Furthermore, the type of a reference model suitable for an output form is set in advance in consideration of various types of three-dimensional output (three-dimensional printing, lenticular printing, three-dimensional animation and the like), so that it is possible to enable a general user to directly process the restoration to the output of a his/her three-dimensional avatar.

As described hitherto, the present invention can easily restore the three-dimensional appearance of a whole body or a face of a subject with one or a plurality of cameras equipped with a depth sensor and can modify the three-dimensional appearance using a three-dimensional model transition technology to create a three-dimensional avatar resembling, to the greatest possible degree, a model restored from a three-dimensional light reference model having no noise. Furthermore, the present invention enjoys the advantage of enabling a general user to directly process the restoration to produce his/her own three-dimensional avatar by setting the type of a reference model suitable for an output form in advance in consideration of various types of three-dimensional output (three-dimensional printing, lenticular printing, three-dimensional animation and the like).

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for generating three-dimensional output data, comprising:
an acquisition unit for acquiring a three-dimensional model based on depth information and a color image for a user from at least one point of view;
a selection unit for selecting at least one of a plurality of three-dimensional template models based on a type of output and an application according to utilization of the three-dimensional model; and,
a generation unit for modifying at least one of a plurality of three-dimensional template models selected by the selection unit and generating three-dimensional output data based on the three-dimensional model acquired by the acquisition unit.

2. The apparatus of claim 1, wherein the acquisition unit acquires the depth information and the color image through a depth camera.

3. The apparatus of claim 1, wherein the acquisition unit acquires the depth information through a depth camera and acquires the color image through a color camera.

4. The apparatus of claim 3, wherein the acquisition unit acquires the three-dimensional model based on the depth information and the color image acquired, respectively, from the depth camera and the color camera, said depth camera being located so that its depth sensor is coincident in the positions on X-Y axes of a three-dimensional coordinate system with a center of the lens of the color camera.

5. The apparatus of claim 4, wherein the acquisition unit comprises a conversion section for performing coordinate transformation of a three-dimensional point cloud accumulated in correspondence with real-time movement of a user.

6. The apparatus of claim 5, wherein the acquisition unit further comprises a correction section for performing correction for the depth camera and the color camera to make mapping between the depth information and the color image.

7. The apparatus of claim 6, wherein the acquisition unit further comprises:
an alignment section for aligning a color texture and a three-dimensional appearance acquired by the depth camera and the color camera corrected by the correction section to generate the three-dimensional model.

8. The apparatus of claim 1, wherein the selection unit selects at least one of a three-dimensional template model corresponding to three-dimensional printing and a three-dimensional template model corresponding to a three-dimensional animation application.

9. The apparatus of claim 8, wherein the three-dimensional template model corresponding to three-dimensional printing is hollow and has a predetermined outer surface thickness based on material efficiency for the printing of the output, and stability of the output itself.

10. The apparatus of claim 8, wherein the three-dimensional template model corresponding to a three-dimensional animation application is obtained by limiting a number of vertices of the three-dimensional template model to a predetermined number or less, or is obtained by reducing a number of vertices for a part, in which movement in the three-dimensional template model has a value equal to or less than a predetermined value by a predetermined number.

11. A method of generating three-dimensional output data, comprising:
acquiring, by an acquisition unit, a three-dimensional model based on depth information and a color image for a user of at least one point of view;
selecting, by a selection unit, at least one of a plurality of three-dimensional template models based on a type of output and an application according to utilization of the three-dimensional model; and
modifying, by a generation unit, at least one of a plurality of three-dimensional template models selected by the selection unit and generating three-dimensional output data based on the three-dimensional model acquired by the acquisition unit.

12. The method of claim 11, wherein the acquiring is carried out by use of a depth camera to acquire the depth information and the color image.

13. The method of claim 11, wherein the acquiring is carried out by use of a depth camera to acquire the depth information and by use of a color camera to acquire the color image.

14. The method of claim 13, wherein the acquiring is carried out based on the depth information and the color image acquired, respectively, from the depth camera and the color camera, said depth camera being located so that its depth sensor is coincident in the positions on X-Y axes of a three-dimensional coordinate system with a center of the lens of the color camera.

15. The method of claim 14, wherein the acquiring comprises:
performing, by a conversion section, coordinate transformation of a three-dimensional point cloud accumulated in correspondence with real-time movement of a user.

16. The method of claim 15, wherein the acquiring further comprises:
performing, by a correction section, correction for the depth camera and the color camera and performing mapping between the depth information and the color image, after the coordinate transformation of a three-dimensional point cloud is performed.

17. The method of claim 16, wherein the acquisition unit further comprises:
aligning, by an alignment section, a color texture and a three-dimensional appearance acquired by the depth camera and the color camera corrected in the mapping between the depth information and the color image, and generating the three-dimensional model, after the mapping between the depth information and the color image is performed.

18. The method of claim 11, wherein the selecting is carried out by selecting at least one of a three-dimensional template model corresponding to three-dimensional printing and a three-dimensional template model corresponding to a three-dimensional animation application is selected.

19. The method of claim 18, wherein the three-dimensional template model corresponding to three-dimensional printing is hollow and has a predetermined outer surface thickness based on material efficiency for the printing of the output, and stability of the output itself.

20. The method of claim 18, wherein the three-dimensional template model corresponding to a three-dimensional animation application is obtained by limiting a number of vertices of the three-dimensional template model to a predetermined number or less, or is obtained by reducing a number of vertices for a part, in which movement in the three-dimensional template model has a value equal to or less than a predetermined value, by a predetermined number.
